(19) United States
(12) Patent Application Publication
(10) Pub. No.: US 2003/0140099 A1
(43) Pub. Date: Jul. 24, 2003

(54) Method and apparatus for hard address conflict resolution for enclosures in a loop network

(75) Inventors: Reginald Beer, Eastleigh (GB); Paul Nicholas Cashman, Alton (GB); Paul Hooton, Eastleigh (GB); Ian David Judd, Winchester (GB); Robert Frank Maddock, Christchurch (GB); Neil Morris, Southsea (GB); Robert Bruce Nicholson, Southsea (GB); Paul Jonathan Quelch, Emsworth (GB); Barry Douglas White, Winchester (GB)

Correspondence Address: HARRINGTON & SMITH, LLP, 4 RESEARCH DRIVE, SHELTON, CT, 06484-6212, US

(73) Assignee: International Business Machines Corporation, Armonk, NY (US)

(21) Appl. No.: 10/290,796

(22) Filed: Nov. 8, 2002

(30) Foreign Application Priority Data
Jan. 19, 2002 (GB) 0201208.6

(51) Int. Cl. G06F 15/16

(52) U.S. Cl. 709/203

(57) ABSTRACT

A method and apparatus are provided for hard address conflict resolution for enclosures in a loop network (200). The loop network (200) has: a loop (202); a host means (201) on or connected to the loop (202); a plurality of devices (207) on or connected to the loop (202); and at least one enclosure containing one or more devices (207). Each device (207) has an address means. Each enclosure has an enclosure control device (208) with control over devices (207) in that enclosure. Each enclosure control device (208) has an address means. The method includes, at the start up of the loop network (200), setting the address means of the enclosure control devices (208) to a default value. Each device (207) is then entered in the loop (202) in a reset state in which only the enclosure control devices (208) and the host means (201) are active in the loop (202). The host means (201) sends a command to each enclosure control device (208) to set the address means of the enclosure control devices (208) such that no two enclosure control devices (208) on a loop (202) have the same address. Each enclosure control device (208) allocates addresses to the address means of the devices (207) in its enclosure such that no two devices (207) in the same enclosure have the same address. The Loop Initialisation Procedure, for example as specified in Fibre Channel Arbitrated Loop (FC-AL), can then be commenced.

### FIELD OF THE INVENTION

This invention relates to a method and apparatus for hard address conflict resolution of enclosures in a loop network. In particular, the invention relates to loop networks in the form of Fibre Channel Arbitrated Loops. The invention could equally apply to other loop networks.

### BACKGROUND OF THE INVENTION

Many computer peripheral interconnections use a simple addressing scheme to differentiate between different devices. A typical small computer system might have up to 15 SCSI (Small Computer System Interface) storage devices on the same bus. Larger computer systems could have up to 127 FC-AL (Fibre Channel Arbitrated Loop) storage devices. Each storage device must have a different address if the bus is to operate correctly. The address settings of SCSI storage devices, and groups of FC-AL storage devices, are usually controlled by switches.

Fibre Channel Arbitrated Loop (FC-AL) architecture is a member of the Fibre Channel family of ANSI standard protocols. FC-AL is typically used for connecting together computer peripherals, in particular disk drives. The FC-AL architecture is described in NCITS working draft proposal, American National Standard for Information Technology “Fibre Channel Arbitrated Loop (FC-AL-2) Revision 7.0”, Apr. 1, 1999 and “Fibre Channel Arbitrated Loop (FC-AL-3) Version 1.0”, Sep. 20, 1999.

Electronic data systems can be interconnected using network communication systems. Area-wide networks and channels are two technologies that have been developed for computer network architectures. Area-wide networks (e.g. LANs and WANs) offer flexibility and relatively large distance capabilities. Channels, such as the Small Computer System Interface (SCSI), have been developed for high performance and reliability. Channels typically use dedicated short-distance connections between computers or between computers and peripherals.

Fibre Channel technology has been developed from optical point-to-point communication of two systems or a system and a subsystem. It has evolved to include electronic (non-optical) implementations and has the ability to connect many devices, including disk drives, in a relatively low-cost manner. This addition to the Fibre Channel specifications is called Fibre Channel Arbitrated Loop (FC-AL).

Fibre Channel technology consists of an integrated set of standards that defines new protocols for flexible information transfer using several interconnection topologies. Fibre Channel technology can be used to connect large amounts of disk storage to a server or cluster of servers. Compared to Small Computer Systems Interface (SCSI), Fibre Channel technology supports greater performance, scalability, availability, and distance for attaching storage systems to network servers.

Fibre Channel Arbitrated Loop (FC-AL) is a loop architecture as opposed to a bus architecture like SCSI. FC-AL is a serial interface, where data and control signals pass along a single path rather than moving in parallel across multiple conductors as is the case with SCSI. Serial interfaces have many advantages including: increased reliability due to point-to-point use in communications; dual-porting capability, so data can be transferred over two independent data paths, enhancing speed and reliability; and simplified cabling and increased connectivity which are important in multi-drive environments. As a direct disk attachment interface, FC-AL has greatly enhanced I/O performance.

Devices are connected to a FC-AL using hardware which is termed a “port”. A device which has connections for two loops has two ports or is “dual-ported”.

The operation of FC-AL involves a number of ports connected such that each port's transmitter is connected to the next port's receiver, and so on, forming a loop. Each port's receiver has an elasticity buffer that captures the incoming FC-AL frame or words and is then used to regenerate the FC-AL word as it is re-transmitted. This buffer exists to deal with slight clocking variations that occur. Each port receives a word, and then transmits that word to the next port, unless the port itself is the destination of that word, in which case it is consumed. The nature of FC-AL is therefore such that each intermediate port between the originating port and the destination port gets to ‘see’ each word as it passes around the FC-AL loop.

FC-AL architecture may be in the form of a single loop. Often two independent loops are used to connect the same devices in the form of dual loops. The aim of these loops is to provide an alternative path to devices on a loop should one loop fail. A single fault should not cause both loops to fail simultaneously. More than two loops can also be used.

FC-AL devices typically have two sets of connections allowing them to be attached to two FC-ALs. Thus, in a typical configuration, two independent loops exist and each device is physically connected to both loops. When the system is working optimally, there are two possible loops that can be used to access any dual-ported device.

A FC-AL can incorporate bypass circuits with the aim of making the FC-AL interface sufficiently robust to permit devices to be removed from the loop without interrupting throughput and sacrificing data integrity. If a disk drive fails, port bypass circuits attempt to route around the problem so all disk drives on the loop remain accessible. Without port bypass circuits a fault in any device will break the loop.

In dual loops, port bypass circuits are provided for each loop and these provide additional protection against faults. A port can be bypassed on one loop while remaining active on the dual loop.

A typical FC-AL may have one or two host bus adapters (HBA) and a set of approximately six disk drive enclosures or drawers, each of which may contain a set of ten to sixteen disk drives connected in slots in the enclosures. There is a physical cable connection between each enclosure and the HBA in the FC-AL. Also, there is a connection internal to the enclosure or drawer, between the cable connector and each disk drive in the enclosure or drawer, as well as other components within the enclosure or drawer, e.g. SES device (SCSI Enclosure Services node) or other enclosure services devices.

FC-AL products have a 7-bit hard address setting for the FC-AL devices. Other loop topologies may have other number of bits. Some of the bits are used to identify the enclosure and the remaining bits of the address identify the devices within that enclosure. There must be sufficient bits for all the devices in an enclosure to be identified individually. In one example of a typical FC-AL system, an enclosure address switch sets the most significant 3 bits of the address and the least significant 4 bits of the address are used to differentiate between the 16 devices within the enclosures. The resultant address is of the form [ene-number, slot-number].

If two enclosures within the same FC-AL loop have the same address switch setting, there will be a bus conflict. The FC-AL addressing scheme is quite sophisticated, so in this case the loop initialisation procedure will result in some of the devices using a method called “soft addressing”.

The loop initialisation sequence allocates addresses for devices called AL_PAs (Arbitrated Loop Physical Addresses). If there is a hard address conflict, a soft address is allocated to the device. The SES node does not know the soft address of a device and therefore it is advantageous for the AL_PAs to be in the form of the hard addresses with no hard address conflict.

The described method involves design changes to an enclosure. A loop network can be built that contains enclosures which do not include the design changes (non-compliant enclosures) and the present invention can be applied by first allocating addresses to the non-compliant enclosures.

The aim of the present invention is to provide a method which removes hard address conflicts of enclosures in a loop network.

### DISCLOSURE OF THE INVENTION

According to a first aspect of the present invention there is provided a method for hard address conflict resolution for enclosures in a loop network, the loop network having: a loop; a host means on or connected to the loop; a plurality of devices on or connected to the loop, each device having an address means; at least one enclosure containing one or more devices; and an enclosure control device with control over the devices in an enclosure, each enclosure control device having an address means; the method comprising: at the start up of the loop network, setting the address means of the enclosure control devices to a default value; entering the loop in a reset state in which only the enclosure control devices and the host means are active in the loop; means to set the address means of the enclosure control devices such that no two enclosure control devices on a loop have the same address; each enclosure control device allocating addresses to the address means of the devices in its enclosure such that no two devices in an enclosure have the same address; and commencing a loop initialisation procedure.

The host means may set the address means of the enclosure control devices. Alternatively, the enclosure control devices may democratically set their address means. As another alternative, a higher agent may set the address means of the enclosure control devices. The higher agent may be a human operator who manually sets the address means of the enclosure control devices.

The enclosure control device may bypass from the loop a device in the enclosure.

The address means of a device may be in the form of input pins. The input pins may include a number of pins identifying the enclosure in which the device is located and a further number of pins identifying the device within the enclosure.

The address means of the enclosure control device has a display means for displaying the address. The display means may be an LED or LCD display.

The loop initialisation procedure may include the host means interrogating the devices to obtain their addresses formed of the enclosure control device address and the device address.

The loop network may be a Fibre Channel Arbitrated Loop (FC-AL) network with one or more loops. The host means may be a host bus adapter. The enclosure control device may be a SCSI enclosure services (SES) device or a SAF-TE device with control over the devices in an enclosure. The devices may be storage devices.

According to a second aspect of the present invention there is provided an apparatus for hard address conflict resolution for enclosures in a loop network, the loop network having: a loop; a host means on or connected to the loop; a plurality of devices on or connected to the loop, each device having an address means; at least one enclosure containing one or more devices; an enclosure control device with control over the devices in an enclosure, each enclosure control device having an address means; means for setting the address means of the enclosure control devices to a default value at the start up of the loop network; means for entering the loop in a reset state in which only the enclosure control devices and the host means are active in the loop; means for setting the address means of the enclosure control devices such that no two enclosure control devices on a loop have the same address; each enclosure control device having means for allocating addresses to the address means of the devices in its enclosure such that no two devices in an enclosure have the same address.

The enclosure control device may includes means to bypass from the loop a device in the enclosure.

The address means of a device may be in the form of input pins. The input pins may include a number of pins identifying the enclosure in which the device is located and a further number of pins identifying the device within the enclosure,

The address means of the enclosure control device has a display means for displaying the address. The display means may be an LED or LCD display.

The loop network may be a Fibre Channel Arbitrated Loop (FC-AL) network with one or more loops. The host means may be a host bus adapter. The enclosure control device may be a SCSI enclosure services (SES) device or a SAF-TE device with control over the devices in an enclosure. The devices may be storage devices.

According to a third aspect of the present invention there is provided a computer program product stored on a computer readable storage medium comprising computer readable program code means for hard address conflict resolution for enclosures in a loop network, the loop network having: a loop; a host means on or connected to the loop; a plurality of devices on or connected to the loop, each device having an address means; at least one enclosure containing one or more devices; and an enclosure control device with control over the devices in an enclosure, each enclosure control device having an address means; the program code means performing the steps of: at the start up of the loop network, setting the address means of the enclosure control devices to a default value; entering the loop in a reset state in which only the enclosure control devices and the host means are active in the loop; means to set the address means of the enclosure control devices such that no two enclosure control devices on a loop have the same address; each enclosure control device allocating addresses to the address means of the devices in its enclosure such that no two devices in an enclosure have the same address; and commencing a loop initialisation procedure.

### BRIEF DESCRIPTION OF THE DRAWINGS

Embodiments of the invention are now described, by means of examples only, with reference to the accompanying drawings in which:

FIG. 1A is a diagram of a dual loop network in accordance with the prior art;

FIG. 1B is a diagram of a detail of FIG. 1A showing a bypass port of a device on the loop network;

FIG. 2A is a diagram of a single loop network in accordance with the prior art;

FIG. 2B shows the single loop network of FIG. 2A in accordance with the present invention; and

FIG. 3 is a flow diagram of a method in accordance with the present invention.

### DESCRIPTION OF THE PREFERRED EMBODIMENTS

A loop network system with a plurality of serially connected ports in the form of a Fibre Channel Arbitrated Loop (FC-AL) is described for connecting together computer peripheral devices, in particular disk drives. The described embodiments are given in the context of FC-AL architecture although the described method and apparatus could be applied to any unidirectional loop network.

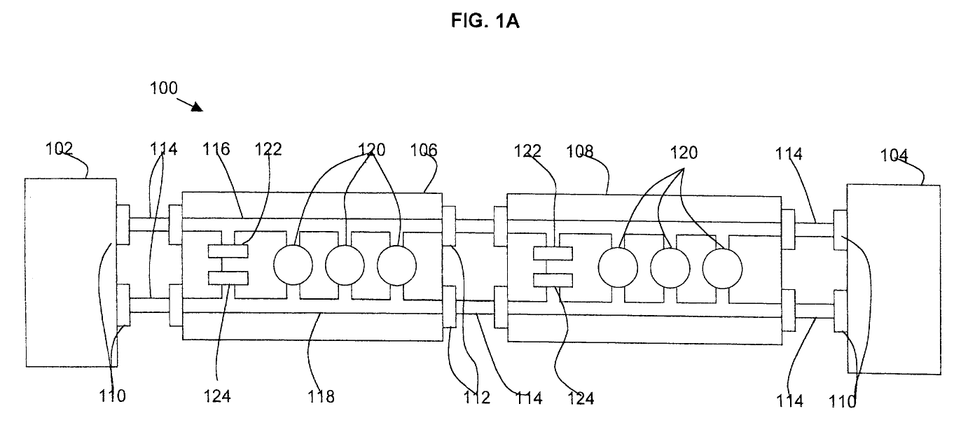

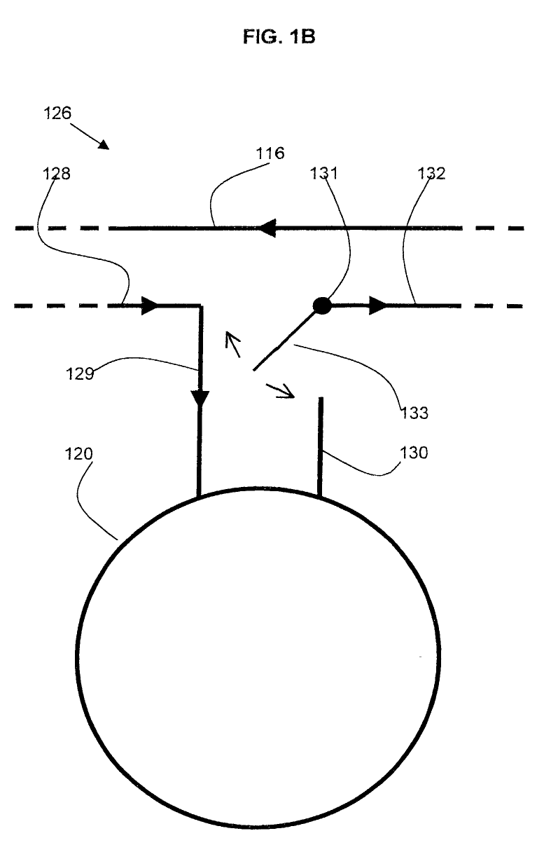

Referring to FIG. 1A, an exemplary loop network 100 is shown in the form of a Fibre Channel Arbitrated Loop with two host bus adapters 102, 104. FIG. 1A shows one form of a loop network on which the present invention may be practiced. However, not all the components of the loop network 100 of FIG. 1A are essential for the operation of the present invention.

The loop network 100 in the shown embodiment has two enclosures 106, 108. Each enclosure in this embodiment has three disk drives 120 although in practice there are usually 10 or more disk drives in an enclosure. Dual loops 116, 118 each connect the components in the loop network 100. A first loop 116 is shown along the top of the loop network 100 in the diagram and a second loop 118 is shown along the bottom of the loop network 100 in the diagram.

The adapters 102, 104 have external connectors 110 for cables 114 connecting each loop 116, 118 from the adapters 102, 104 to external connectors 112 of the enclosures 106, 108. Cables 114 also connect the two enclosures 106, 108 such that each loop 116, 118 passes from one enclosure 106 to the next enclosure 108.

Each loop 116, 118 passes from the first adapter 102 via an adapter external connector 110, a cable 114 and an enclosure external connector 112 to the first enclosure 106. In the first enclosure 106 of the exemplary loop network 100, each loop 116, 118 passes through its own enclosure control device 122, 124 which may be, for example, a SES (SCSI Enclosure Services) device or a SAF-TE device and then through each of the disk drives 120 in turn. The two loops 116, 118 both pass through the same shared disk drives 120. Each loop 116, 118 then leaves the first enclosure via an enclosure external connector 112 and passes through a cable 114 to a second enclosure 108 which it enters via an enclosure external connector 112. The second enclosure 108 has the same set of components as the first enclosure 106. Each loop 116, 118, after passing through the second enclosure 108 is connected to the second adapter 104 via enclosure external connectors 112, cables 114 and adapter external connectors 110.

In each enclosure 106, 108, a loop 116 enters from an external connector 112 and is routed through each of the disk drives 120 and an SES device 122, 124. Each disk drive 120 or enclosure control device 122, 124 has a bypass circuit to enable it to be bypassed by the loop, if required. The disk drives 120 are examples of dual port devices in that they are common to both the loops 116, 118 of the loop network 100.

An enclosure control device 122, 124 is provided on each loop 116, 118 in each enclosure and the two enclosure control devices 122, 124 are connected together through the enclosure's backplane. One enclosure control device can be used to control the other enclosure control device. A enclosure control device manages an enclosure and provides a point of control for that enclosure. It can monitor parameters such as power and cooling and obtain information as to which slots for disk drives are occupied. The enclosure control devices can be in the form of SES devices which accept a limited set of SCSI commands. Enclosure control devices can be used to instruct a bypass of a disk drive and to check which disk drives are bypassed.

In the embodiment shown in FIG. 1A, a dual loop network 100 is shown by way of example, with two enclosures 106, 108 each with three disk drives 120 and two enclosure control devices 122, 124, one for each loop. Typical loop networks may have one or two host bus adapters and a set of six or so disk drive enclosures each of which may typically contain a set of ten to sixteen disk drives.

All devices in the loop 100, including host bus adapters 102, 104, disk drives 120 and any enclosure controllers 122, 124 have hardware connections to a loop 116, 118 referred to as ports. Each port has a receiver and a transmitter. The ports are connected such that each port's transmitter is connected to the next port's receiver, and so on, forming the loop 116, 118.

FIG. 1B is a schematic detail of a bypass 126 for a device 120 in the first loop 116. The loop 116 has a path 128 travelling from left to right which is routed off along a path 129 to travel to the device 120. The loop 116 returns from the device 120 along a return path 130 parallel to the path 129 to the device 120. The return path 130 meets a junction 131 and continues the left to right path 132 of the loop 116 towards the next device 120. The junction 131 in effect has a switch 133 which can join the left to right paths 128, 132 to bypass the device 120.

During initialisation of a loop, a Loop Initialisation Procedure allows each port to obtain an Arbitrated Loop Physical Address (AL_PA) that is unique within the loop for that port. This effectively uniquely identifies each port in a loop.

The AL_PAs can be defined by previous addresses, assigned hardware addresses or software addresses. If there are multiple enclosures, each address indicates the enclosure and the device within the enclosure ensuring that each port in a loop has a unique address.

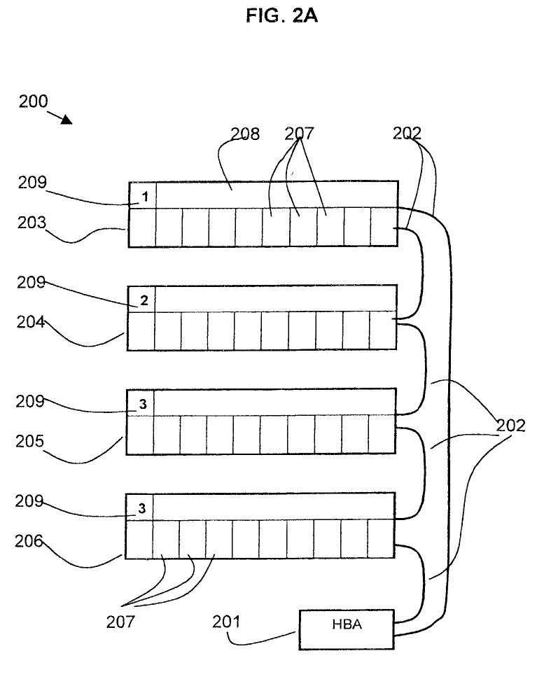

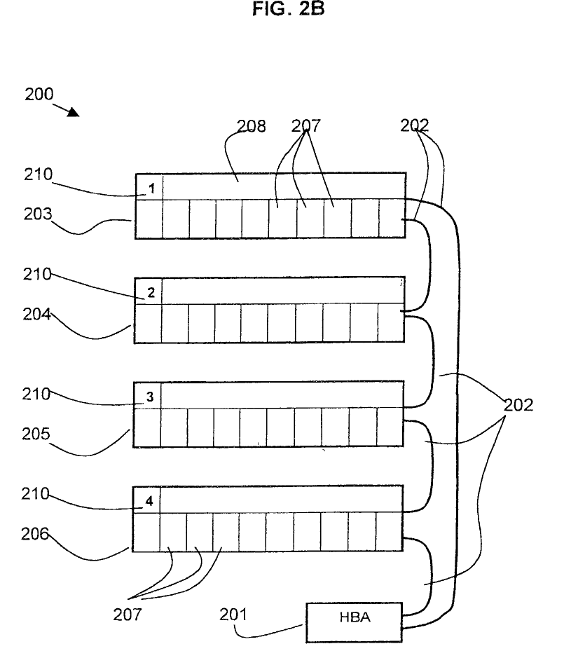

FIGS. 2A and 2B show a simple configuration of a loop network 200. The loop network 200 has a single Host Bus Adapter (HBA) 201 connected in a single loop 202 with four enclosures 203, 204, 205, 206, each of which contains 10 disk drives 207 and one enclosure control device 208.

In FIG. 2A, each enclosure 203, 204, 205, 206 includes an address switch 209 in accordance with the prior art. In the illustrated arrangement, two of the enclosures 205, 206 have their address switches set to the same address “3”. This will cause a conflict in the hard addresses of devices in these two enclosures, so the loop initialisation algorithm will implement soft addressing in the loop for the allocation of the AL_PA to each port on the loop network 200.

FIG. 2B shows an embodiment in accordance with the present invention in which the enclosure address switches 209 have been replaced with address indicators 210. At power-on time, all enclosures 203, 204, 205, 206 will default to address 0. All the disk drives 207 will be held in a reset state, so that the only devices on the FC-AL bus loop will be the HBA 201 and the enclosure control devices 208.

As part of the recovery process, the HBA 201 will send a command to each of the enclosure control devices 208 assigning it a unique enclosure address in the range of 0 to 7. (If there are more than 7 enclosures, this is handled by the system software as an invalid configuration.) Each enclosure control device 208 will then present a 7-bit address to the Select-ID input pins of the disk drives 207 within it. The reset signal is then removed, causing all the disk drives 207 to sample their 7-bit address input pins. The most significant 3 bits of that address with be the “enclosure address”. The least significant 4 bits of that address will be the slot number (0-15). It will be appreciated that any arrangement of bits identifying an enclosure number and a slot number can be used.

At the end of the discovery process, the HBA 201 will send a Loop Initialisation Primitive (LIP) around the loop 202. Each disk drive 207 will then use its Select-ID address value for its hard address. All disk drives in the system are now guaranteed to have a non-conflicting hard address.

The Standard, SFF-8067, Revision 2.0, Nov. 9, 1998, defines the signals and connectors used in Fibre Channel applications.

Each enclosure 203, 204, 205, 206 optionally has some means to display its address, for example a 7-segment LED or LCD display. A user can easily determine the enclosure addresses by looking at the displays. When a group of enclosures are powered on together, the user will see them automatically adopting the correct addresses. This results in a very intuitive system with a much reduced chance of human error during installation and configuration.

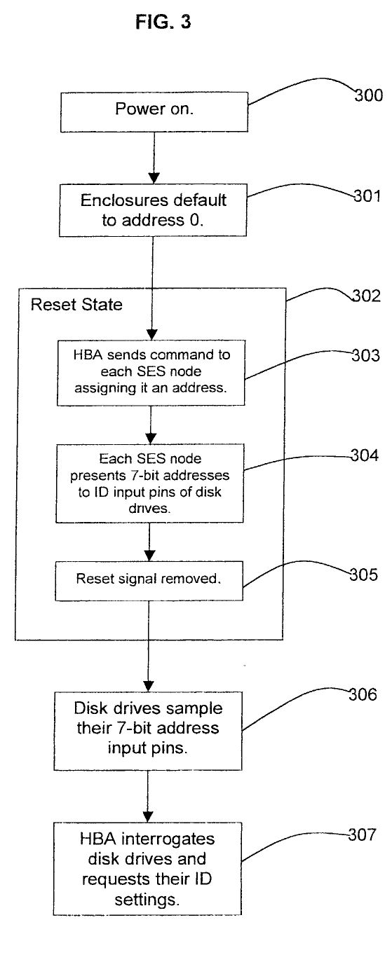

Referring to FIG. 3, a flow diagram of the method of resolving hard address conflict for enclosures is shown. The first step 300 is power-on in the loop network. At step 301, all enclosures in the loop network default to address 0. The disk drives of the enclosures are held in a reset state 302. During the reset state, the HBA sends a command to each of the enclosure control devices assigning it a unique enclosure address 303. Each enclosure control device presents a 7-bit address to each of the disk drives in its enclosure 304. The reset state 302 is terminated by removing the reset signal.

Each disk drive samples its 7-bit address input pins 306. The HBA interrogates the disk drives and requests their ID settings 307. In this way, there is no conflict between hard addresses of enclosure on the loop network and each disk drive on the loop network has a unique address.

Although disk drives are referred to as the devices within enclosures, it should be appreciated that other forms of device may be connected within an enclosure.

The method described herein is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. A method for hard address conflict resolution for enclosures in a loop network, the loop network having:
a loop;
a host means on or connected to the loop;
a plurality of devices on or connected to the loop, each device having an address means;
at least one enclosure containing one or more devices; and
an enclosure control device with control over the devices in an enclosure, each enclosure control device having an address means;
the method comprising:
at the start up of the loop network, setting the address means of the enclosure control devices to a default value;
entering the loop in a reset state in which only the enclosure control devices and the host means are active in the loop;
means to set the address means of the enclosure control devices such that no two enclosure control devices on a loop have the same address;
each enclosure control device allocating addresses to the address means of the devices in its enclosure such that no two devices in an enclosure have the same address; and commencing a loop initialisation procedure.

2. A method as claimed in claim 1, wherein the host means sets the address means of the enclosure control devices.

3. A method as claimed in claim 1, wherein enclosure control devices democratically set their address means.

4. A method as claimed in claim 1, wherein a higher agent sets the address means of the enclosure control devices.

5. A method as claimed in claim 1, wherein the enclosure control device can bypass from the loop a device in the enclosure.

6. A method as claimed in claim 1, wherein the address means of a device is in the form of input pins.

7. A method as claimed in claim 1, wherein the address means of the enclosure control device has a display means for displaying the address.

8. A method as claimed in claim 5, wherein the display means is an LED or LCD display.

9. A method as claimed in claim 1, wherein the loop initialisation procedure includes the host means interrogating the devices to obtain their addresses formed of the enclosure control device address and the device address.

10. A method as claimed in claim 1, wherein the loop network is a Fibre Channel Arbitrated Loop (FC-AL) network with one or more loops.

11. A method as claimed in claim 10, wherein the host means is a host bus adapter.

12. A method as claimed in claim 10, wherein the enclosure control device is a SCSI enclosure services (SES) device or a SAF-TE device with control over the devices in an enclosure.

13. A method as claimed in claim 1, wherein the devices are storage devices.

14. Apparatus for hard address conflict resolution for enclosures in a loop network, the loop network having:
a loop;
a host means on or connected to the loop;
a plurality of devices on or connected to the loop, each device having an address means;
at least one enclosure containing one or more devices;
an enclosure control device with control over the devices in an enclosure, each enclosure control device having an address means;
means for setting the address means of the enclosure control devices to a default value at the start up of the loop network;
means for entering the loop in a reset state in which only the enclosure control devices and the host means are active in the loop;
means for setting the address means of the enclosure control devices such that no two enclosure control devices on a loop have the same address;
each enclosure control device having means for allocating addresses to the address means of the devices in its enclosure such that no two devices in an enclosure have the same address.

15. An apparatus as claimed in claim 14, wherein the enclosure control device has bypass means to bypass from the loop a device in the enclosure.

16. An apparatus as claimed in claim 14, wherein the address means of a device is in the form of input pins.

17. An apparatus as claimed in claim 14, wherein the address means of the enclosure control device has a display means for displaying the address.

18. An apparatus as claimed in claim 17, wherein the display means is an LED or LCD display.

19. An apparatus as claimed in claim 14, wherein the loop network is a Fibre Channel Arbitrated Loop (FC-AL) network with one or more loops.

20. An apparatus as claimed in claim 19, wherein the host means is a host bus adapter.

21. A method as claimed in claim 19, wherein the enclosure control device is a SCSI enclosure services (SES) device or a SAF-TE device with control over the devices in an enclosure.

22. A method as claimed in claim 14, wherein the devices are storage devices.

23. A computer program product stored on a computer readable storage medium comprising computer readable program code means for hard address conflict resolution for enclosures in a loop network, the loop network having: a loop; a host means on or connected to the loop; a plurality of devices on or connected to the loop, each device having an address means; at least one enclosure containing one or more devices; and an enclosure control device with control over the devices in an enclosure, each enclosure control device having an address means; the program code means performing the steps of:
at the start up of the loop network, setting the address means of the enclosure control devices to a default value;
entering the loop in a reset state in which only the enclosure control devices and the host means are active in the loop;
means to set the address means of the enclosure control devices such that no two enclosure control devices on a loop have the same address;
each enclosure control device allocating addresses to the address means of the devices in its enclosure such that no two devices in an enclosure have the same address; and commencing a loop initialisation procedure.
